(19) United States
(12) Patent Application Publication
(10) Pub. No.: US 2019/0323261 A1
(43) Pub. Date: Oct. 24, 2019

(54) IMPROVED DOOR LOCK

(71) Applicant: Graeme MCGRATH, Queensland (AU)

(72) Inventor: Graeme McGrath, Grange Queensland (AU)

(21) Appl. No.: 16/465,010

(22) PCT Filed: Nov. 14, 2017
(86) PCT No.: PCT/AU2017/051249

§ 371 Date: May 29, 2019

(30) Foreign Application Priority Data
Nov. 30, 2016 (AU) 2016904916

(51) Int. Cl. E05B 1/00; E05B 59/00; E05B 47/00; E05B 17/10; G07C 9/00

(52) U.S. Cl. CPC E05B 1/0015; E05B 59/00; E05B 47/0001; E05Y 2900/132; G07C 9/00571; E05B 2047/0058; E05B 17/10

(57) ABSTRACT

A residential door lock system is provided that may reduce the amount of unsightly external locks on the door, provides greater flexibility in the positioning of a handle, and be easy to use. The door lock system includes an elongate handle, configured to extend vertically on an outside of the door, the handle comprising a shaft configured to be gripped by a hand of a user; a locking member, configured to lock and unlock the door; and a digital access system, including a keypad provided in on the shaft of the handle, the digital access system configured to receive an access code from the user, wherein the system is configured to unlock the door using the locking member when the access code is a valid access code.

### TECHNICAL FIELD

The present invention relates to improved door locks.

### BACKGROUND ART

Door locks have long been used to restrict access to buildings, including residential buildings. A typical residential door includes a door handle with a lock positioned either above or below the handle. A deadbolt of the lock, which extends from the door into the door frame, is engaged by a key, and is used to prevent unauthorised opening of the door.

FIG. 1 illustrates a portion of a residential door 100, including a handle 105 and a lock 110, according to the prior art. The lock 110 is positioned directly below the handle 105. In order to open the door 100, the lock 110 is first unlocked with a key (not illustrated), upon which the handle 105 is subsequently used to open the door 100.

More recently, elongate door handles have become popular, where a push/pull handle extends down a side of the door. Such door handles are not only aesthetically pleasing, but also provide a better grip on heavy doors, such as large and solid timber doors.

FIG. 2 illustrates another residential door 200, including an elongate handle 205 and a lock 110, according to the prior art. As the handle 205 is elongate, the lock 110 is positioned beside the handle 205.

A problem with such doors of the prior art is that the lock 110 is generally unsightly, particularly in the context of the handle 205. Furthermore, as the handle 205 is long, it is often impractical to position the lock 110 above or below the handle 205. As a result, the handle 205 is typically positioned further away from an edge of the door 200 to provide space for the lock 110 beside the handle 205, which may again not be aesthetically pleasing.

In short, it is generally problematic to integrate elongate door handles with locks in a visual pleasing manner, and even more so for distinctive styles of door locks. Finally, installation of such door handles and locks is generally labour intensive and time consuming, which is clearly undesirable.

As such, there is clearly a need for an improved door lock.

It will be clearly understood that, if a prior art publication is referred to herein, this reference does not constitute an admission that the publication forms part of the common general knowledge in the art in Australia or in any other country.

### SUMMARY OF INVENTION

The present invention is directed to door locks, which may at least partially overcome at least one of the abovementioned disadvantages or provide the consumer with a useful or commercial choice.

With the foregoing in view, the present invention in one form, resides broadly in a residential door lock system including:

an elongate handle, configured to extend vertically on an outside of the door, the handle comprising a shaft configured to be gripped by a hand of a user;

a locking member, configured to lock and unlock the door; and

an digital access system including a keypad provided on the shaft of the handle, the digital access system configured to receive an access code from the user, wherein the system is configured to unlock the door using the locking member when the access code is a valid access code.

Advantageously, the residential door lock system reduces the amount of unsightly external locks on the door, and provides greater flexibility in the positioning of the handle. Furthermore, the system may be easy to use.

Preferably, the locking member comprises a door lock. Preferably, the locking member includes a deadbolt.

Preferably, the keypad is configured to be used by a thumb of the hand of the user which is gripping the shaft of the handle. Suitably the keypad includes a plurality of buttons which may be selected by the user to form the code. The code may be a numerical code.

Preferably, the keypad is positioned on an upper end of handle. Suitably, the keypad is positioned away from a surface of the door.

Preferably, the door lock system includes a controller, coupled to the digital access system and an actuator of the locking member, the controller configured to unlock the door using the actuator when the access code is a valid access code.

The controller may be located on an inside of the door. The controller may be located within an inner door handle.

Preferably, the lock system includes an inner elongate pull handle, configured to be fixed to an inside of the door. The inner elongate pull handle may include a release button, wherein the system is configured to unlock the door using the locking member when the release button is pressed.

The inner elongate pull handle may be substantially the same in overall shape as the elongate handle.

The lock system may include a ball latch, configured to hold the door in a closed position against a strike of a door frame.

The lock system may include a lock box, housing the ball latch and the locking member in the form of a dead bolt.

Preferably, the locking member is configured to be positioned in the door independently of the elongate handle.

Preferably, the system includes a power source, for powering the digital access system. The power source may comprise batteries.

Horizontal stem portions may attach the shaft to the door and space the shaft from a face of the door.

Preferably, the shaft is cylindrical in shape. The shaft may be about 30-50 mm in diameter and/or about 600-900 mm long.

Preferably, the handle is at least partly hollow and configured to house wiring between the locking member and the digital access system. Preferably, the handle is configured to receive one or more batteries.

The handle may include a light, indicating if door is unlocked and/or locked.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a portion of a door, according to the prior art;

FIG. 2 illustrates another door, according to the prior art;

FIG. 3 illustrates a front perspective view of a lock system installed in a door, according to an embodiment of the present invention;

FIG. 4 illustrates a side view of the lock system of FIG. 3, installed on the door;

FIG. 4a illustrates a side view of the lock system installed on the door, as illustrated in FIG. 4, in use;

FIG. 5 illustrates a schematic of the lock system of FIG. 3, according to an embodiment of the present invention; and

FIG. 6 illustrates a front perspective view of a lock system, installed in a door, according to an alternative embodiment of the present invention.

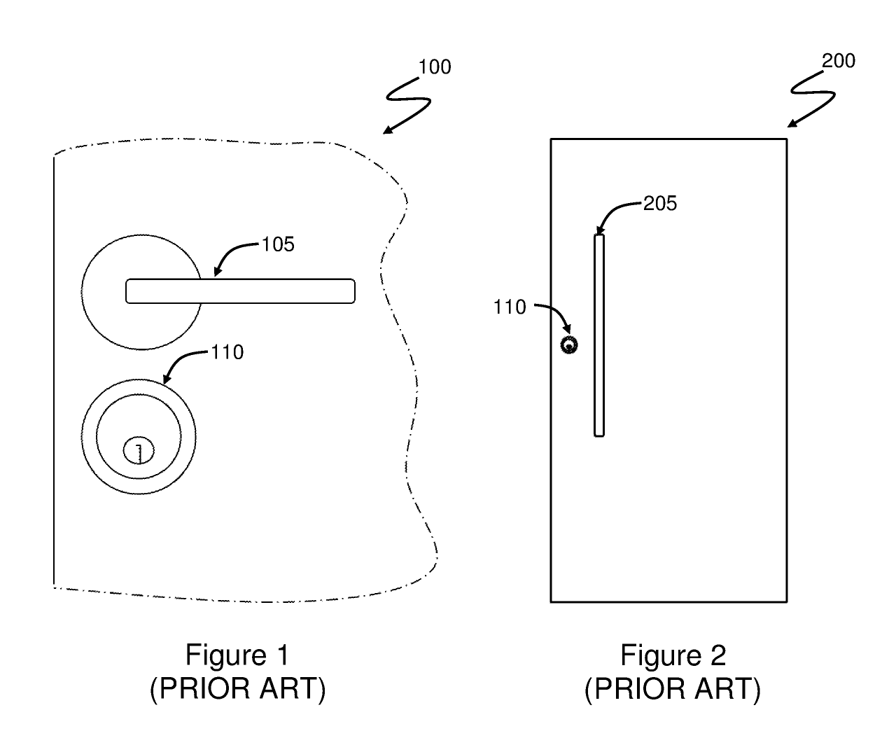

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

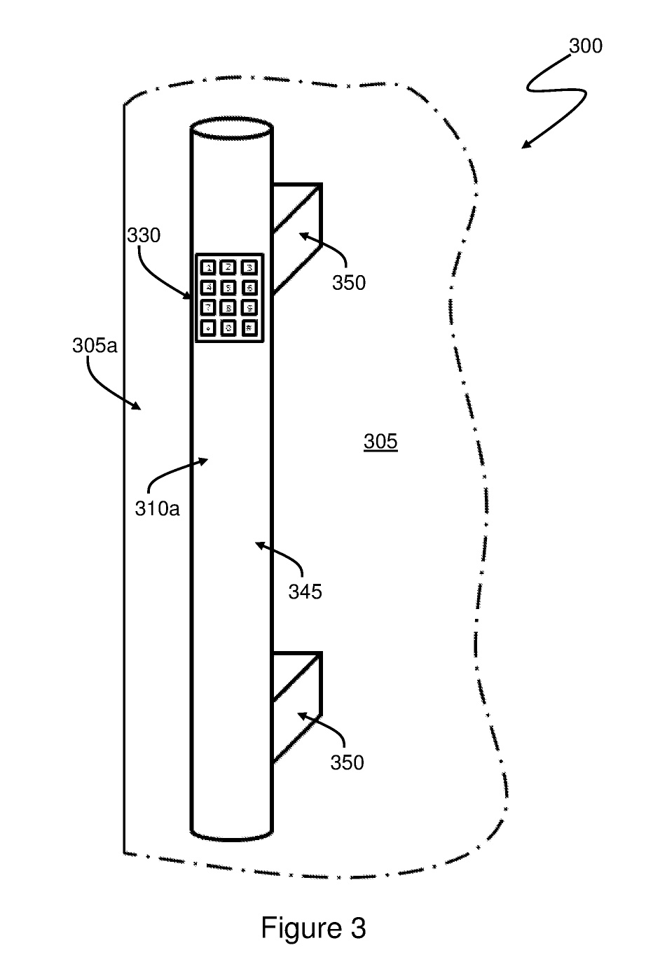

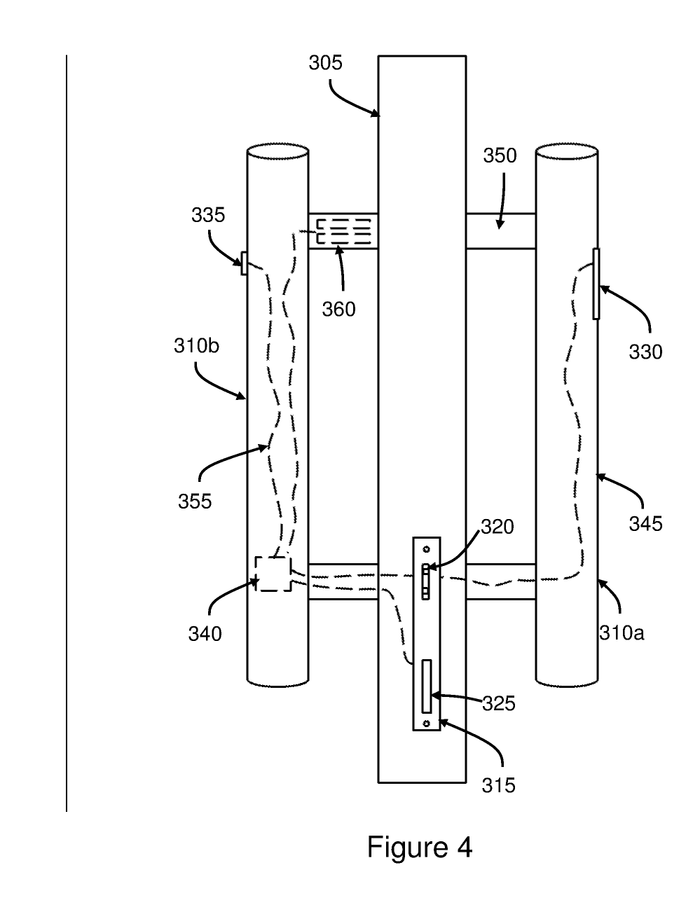

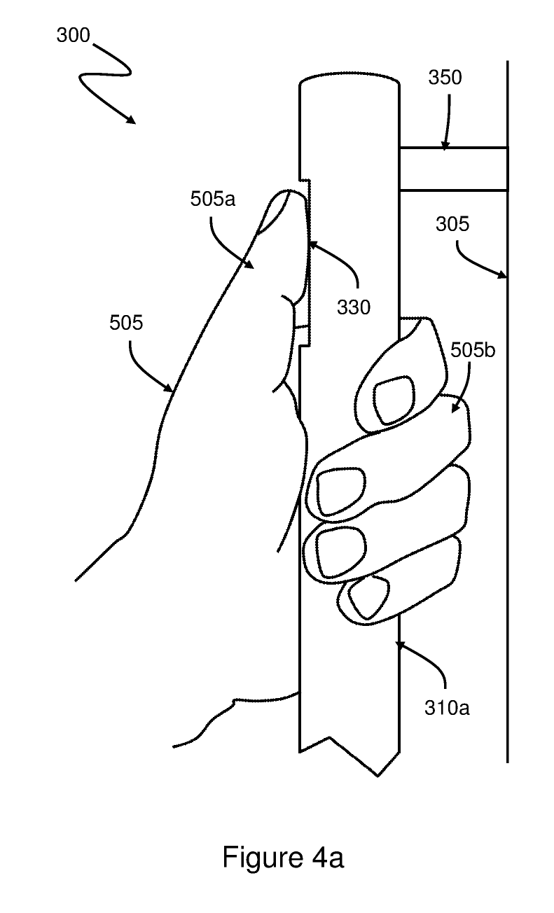

FIG. 3 illustrates a front perspective view of a lock system 300 installed in a door 305, according to an embodiment of the present invention. FIG. 4 illustrates a side view of the lock system 300 installed on the door 305.

The lock system 300 includes an outer elongate pull handle 310a, fixed to an outside of the door 305, and an inner elongate pull handle 310b, fixed to an inside of the door 305. The elongate pull handles 310a, 310b are positioned vertically on a lock stile portion 305a of the door 305, which enables a user to easily open and close the door 305 in a smooth motion.

As best illustrated in FIG. 4, the lock system 300 includes lock box 315 comprising a ball latch 320 and a dead bolt 325. The ball latch 320 holds the door in a closed position against a strike of a door frame, and thus prevents the door 305 from inadvertently opening. The dead bolt 320 is used to lock the door 305, and prevents the door 305 from opening when in a locked configuration, as is well known in the art.

The outer pull handle 310a includes a keypad 330, and the inner pull handle 310b includes a release button 335, both of which are coupled to a controller 340. The controller 340 is configured to receive an entry code from the keypad 330, determine if the entry code is valid, and in such case cause an actuator to release the dead bolt 325, enabling the door 305 to be opened. Similarly, the controller 340 is configured to release the dead bolt 325 when the inner release button 335 is pressed.

The keypad 330 is conveniently located on an upper portion of the outer handle 310a, and as a result, the user may grip the handle 310a, enter the entry code into the keypad 330 using his or her thumb, and pull or push open the door 305, all without substantially changing grip. This is particularly useful if the user is carrying something.

Furthermore, by locating the keypad 330 on the outer handle 310a, rather than on the door 305 directly, for example, installation is significantly simplified. In particular, there is no need to drill or attach a keypad 330 to the door 305 separately to installing the handle 310a.

Finally, the lock box 315 (and thus the deadbolt 325) and the handles 310a, 310b may be placed at any suitable position along the lock stile portion of the door 305, and do not need to be aligned with each other. This provides greater flexibility in installation. As an illustrative example, the lock box 315 may be positioned on the door at a position centrally along a length of the handle 310a, and without there being any visual indication of a location of the lock box when viewing a front of the door 305.

The handles 310a, 310b are substantially similar in overall shape and include vertical shafts 345, and horizontal stem portions 350, attaching the vertical shafts 345 to the door 305 and spacing the vertical shaft 345 from a face of the door 305. Such arrangement allows the user to wrap his or her fingers around the shafts 345 to get a firm grip on the handle 310a, 310b.

The shafts 345 and the horizontal stem portions 350 are substantially hollow, and house wiring 355 from the release button 335 to the controller 340, from the keypad 330 to the controller 340, and from the controller 340 to an actuator of the dead bolt 325. One of the horizontal stems 350 further includes a receptacle for receiving batteries 360, which are coupled to the controller 340 and are configured to power the lock system 100.

FIG. 4a illustrates a side view of an upper portion of the lock system 300 installed on the door 305 in use. In particular, a users hand 505 is engaged with the handle such that the thumb 505a of the hand 505 is adjacent to the keypad 330 and able to interact with buttons thereof, while the fingers 505b of the hand 505 extend around the elongate pull handle 310a, which is in the form of a shaft.

As such, the user is able to easily use the keypad 330 while gripping on the handle 310a, and without changing hand position.

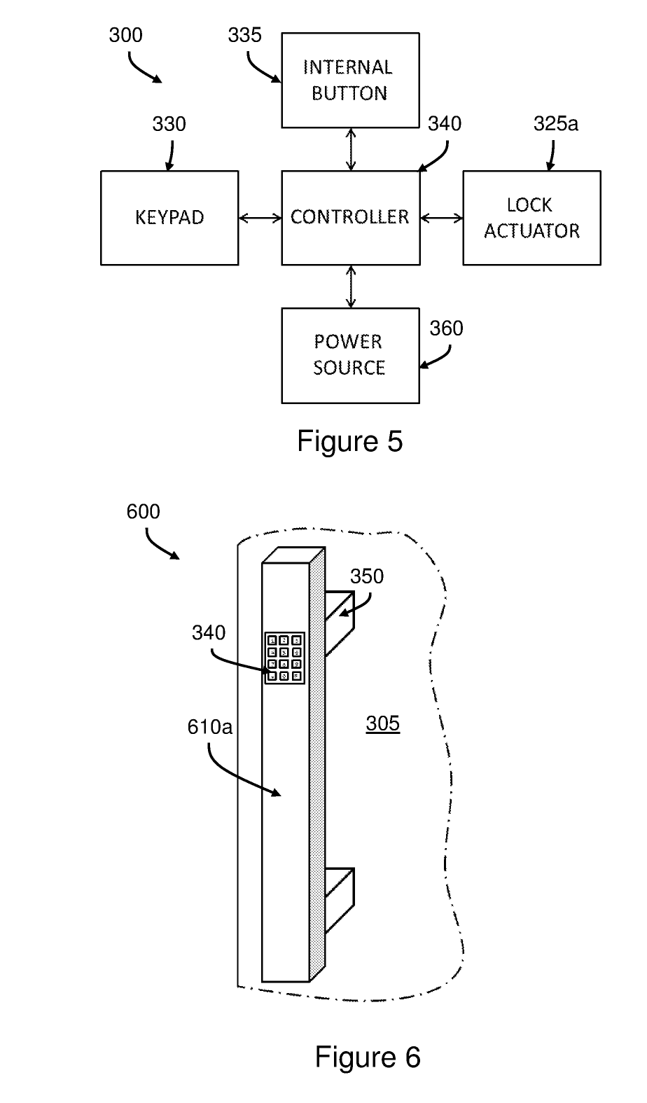

FIG. 5 illustrates a schematic of the lock system 300, according to an embodiment of the present invention.

As can be seen from the schematic, the controller 340 is central and is coupled to each of the internal button 335, the keypad 330, a power source 360 (i.e. batteries), and a lock actuator 325a, which is configured to actuate the deadbolt 325.

As such, the controller 340 receives various inputs (e.g. from the internal button 335, the keypad 330) and locks and/or unlocks the door 305 using the lock actuator 325.

In addition to storing and comparing access codes, the controller 340 may be configured to require an access code only at certain times, e.g. times of the day, or on weekends. Such scenario may be particularly suited to apartment buildings, where access to a common area may be restricted based upon time of day.

The skilled addressee will readily appreciate that other functions may be performed by the controller, including low battery alerts and warnings, error messages, signalling (e.g. whether the door is locked or unlocked), or any other suitable function.

The shafts of the inner and outer handles 110a, 110b are cylindrical in shape and are about 30-50 mm in diameter and about 600-900 mm long. Similarly, the horizontal stems 150 provide a gap of about 50 mm between a face of the door and the shafts. However, the skilled addressee will readily appreciate that other sizes and shapes may be used.

FIG. 6 illustrates a front perspective view of a lock system 600 installed in a door 305, according to an embodiment of the present invention.

The lock system 600 is similar to the lock system 300, but includes inner and outer handles 310a, 310b with rectangular faces, rather than cylindrical handles.

The skilled addressee will, however, readily understand that the handles may take on any suitable shape or cross section.

According to certain embodiments, the lock systems 300, 600 may include indicators for indicating that the door has been unlocked. As an illustrative example, the lock systems 300, 600 may include one or more coloured lights, such as light emitting diodes (LEDs), for indicating that the door has been locked and/or unlocked.

In some situations, the lock systems 300, 600 may be configured to automatically lock after a predetermined interval, or otherwise. This is particularly advantageous at the user needs take no specific action to lock the door.

According to certain embodiments, the lock systems 300, 600 are provided with a mechanical bypass. The mechanical bypass may be key activated, for example, and is useful in case of flat batteries or electrical fault. In such case, the mechanical bypass may be configured to mechanically actuate the deadbolt, either from inside or outside of the door.

While the above systems 300, 600 have been described with reference to various components wiredly coupled to a controller 340, the skilled addressee will readily appreciate that wireless communication may also be used between the various components.

Similarly, as the systems 300, 600 have been described as including batteries, the skilled addressee will readily appreciate that an external power source, e.g. from a mains power source, may be used. Furthermore, the batteries of the system 300, 600 may be coupled to a power supply, such as a solar panel, which may be positioned on the door, or in association therewith, to enable charging of the batteries.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A residential door lock system including:
an elongate handle, configured to extend vertically on an outside of the door, the handle comprising a shaft configured to be gripped by a hand of a user;
a locking member, configured to lock and unlock the door; and
a digital access system including a keypad provided on the shaft of the handle, the digital access system configured to receive an access code from the user, wherein the system is configured to unlock the door using the locking member when the access code is a valid access code.

2. The residential door lock system of claim 1, wherein the locking member comprises a door lock.

3. The residential door lock system of claim 2, wherein the locking member includes a deadbolt.

4. The residential door lock system of claim 1, wherein the keypad is configured to be used by a thumb of the hand of the user which is gripping the shaft of the handle.

5. The residential door lock system of claim 1, wherein the keypad includes a plurality of buttons which may be selected by the user to form the code.

6. The residential door lock system of claim 5, wherein the code comprises a numerical code.

7. The residential door lock system of claim 1, wherein the keypad is positioned on an upper end of handle, or wherein the keypad is positioned away from a surface of the door.

8. (canceled)

9. The residential door lock system of claim 1, further including a controller, coupled to the digital access system and an actuator of the locking member, the controller configured to unlock the door using the actuator when the access code is a valid access code.

10. The residential door lock system of claim 9, wherein the controller is located on an inside of the door.

11. The residential door lock system of claim 10, wherein the controller is located within an inner door handle.

12. The residential door lock system of claim 1, wherein the lock system includes an inner elongate pull handle, configured to be fixed to an inside of the door.

13. The residential door lock system of claim 12, wherein the inner elongate pull handle includes a release button, wherein the system is configured to unlock the door using the locking member when the release button is pressed, or wherein the inner elongate pull handle is substantially the same in overall shape as the elongate handle.

14. (canceled)

15. The residential door lock system of claim 1, including a ball latch, configured to hold the door in a closed position against a strike of a door frame.

16. The residential door lock system of claim 15, including a lock box, housing the ball latch and the locking member in the form of a dead bolt.

17. The residential door lock system of claim 1, wherein the locking member is configured to be positioned in the door independently of the elongate handle, and/or wherein horizontal stem portions attach the shaft to the door and space the shaft from a face of the door.

18. The residential door lock system of claim 1, including a power source, for powering the digital access system.

19. The residential door lock system of claim 18, wherein the power source comprises batteries.

20. (canceled)

21. The residential door lock system of claim 1, wherein the shaft is cylindrical in shape, and/or wherein the handle includes a light, indicating if door is unlocked and/or locked.

22. (canceled)

23. The residential door lock system of claim 1, wherein the handle is at least partly hollow and configured to house wiring between the locking member and the digital access system.

24. The residential door lock system of claim 23, wherein the handle is configured to receive one or more batteries.

25. (canceled)
